(19) United States
(12) Patent Application Publication
(10) Pub. No.: US 2011/0126716 A1
(43) Pub. Date: Jun. 2, 2011

(54) DUST-COLLECTING APPARATUS

(76) Inventor: Mao-Nan CHENG, Fongyuan City (TW)

(21) Appl. No.: 12/627,254

(22) Filed: Nov. 30, 2009

(51) Int. Cl. B01D 46/42; B01D 46/24

(52) U.S. Cl. 96/421

(57) ABSTRACT

A dust-collecting apparatus includes a hollow wind guide box having a forced-draft fan therein. The wind guide box is connected with a dust-collecting bucket and a filter bucket so as to filter external air and maintain the quality of air. A first detector is provided on the dust-collecting bucket of the dust-collecting apparatus. A second detector is provided in the wind guide box and close to the filter bucket. The first detector and the second detector are electrically connected with a display unit. Thereby, the dust-collecting apparatus is capable of reminding the user of cleaning or replacement when the capacity of the dust-collecting bucket is not enough or the filter bucket is blocked.

### BACKGROUND OF THE INVENTION

1. Field of the Invention

The present invention relates to a dust-collecting apparatus.

2. Description of the Prior Art

A dust-collecting apparatus is used to suck dust particles around the work site so as to provide clean and fresh air to the workers. A conventional dust-collecting apparatus comprises a wind guide box. The wind guide box has a wind inlet, a wind outlet, and a dust-collecting opening. A forced-draft fan is provided close to the wind inlet. The wind outlet is fitted with a filter bucket. The dust-collecting opening is fitted with a dust-collecting bucket. The external air enters the dust-collecting apparatus through the wind inlet and the dust particles are filtered through the dust-collecting bucket and the filter bucket so as to exhaust clean air, providing an air filtration effect. However, the capacity of the dust-collecting bucket is restricted. After a period of time, the filter bucket may be blocked. Therefore, the user has to replace or clean the dust-collecting bucket and the filter bucket so as to maintain the filtration effect of the dust-collecting apparatus. The conventional dust-collecting apparatus doesn't have the function to indicate cleaning. For this reason, the user has to check the capacity of the dust-collecting bucket and the blocking level of the filter bucket frequently. This bothers the user very much, and the user subjectively determines the standard of cleaning and replacement by the eyes. This way is not precise and the standard varies with each individual. When the replacement is done early, the cost will increase. When the replacement is done late, it will be difficult to maintain the quality of air. Accordingly, the inventor of the present invention has devoted himself based on his many years of practical experiences to solve this problem.

### SUMMARY OF THE INVENTION

According to the present invention, there is provided a dust-collecting apparatus comprising a base having a hollow wind guide box, the wind guide box being formed with at least one wind inlet and at least one wind outlet; a forced-draft fan disposed on the wind guide box and close to the wind inlet; a hollow wind guide bucket connected to the wind inlet of the wind guide box, the wind guide bucket having at least one inlet and at least one dust-collecting entrance; a dust-collecting bucket connected to the dust-collecting entrance of the wind guide bucket; a filter bucket connected to the wind outlet of the wind guide box; a first detector disposed on the dust-collecting bucket for sending a signal when the capacity of the dust-collecting bucket is not enough; a second detector disposed in the wind guide box and close to the filter bucket for sending a signal when the filter bucket is blocked; and a display unit disposed on the base, the display unit being electrically connected with the first detector and the second detector for receiving and displaying the signals from the first detector and the second detector. Thereby, the dust-collecting apparatus is capable of reminding the user of cleaning or replacement when the capacity of the dust-collecting bucket is not enough or the filter bucket is blocked, such that the user doesn't have to check the dust-collecting bucket and the filter bucket frequently. In addition, the user can set an objective standard through the second detector to replace the filter bucket for maintaining the quality of air and controlling the cost.

### BRIEF DESCRIPTION OF THE DRAWINGS

FIG. 1 is a perspective view according to a preferred embodiment of the present invention;

FIG. 2 is a partially cross-sectional view according to the preferred embodiment of the present invention;

FIG. 3 is a schematic view showing the preferred embodiment of the present invention when in use; and

FIG. 4 is a schematic view of the preferred embodiment of the present invention showing the operation to replace the dust-collecting bucket.

### DETAILED DESCRIPTION OF THE PREFERRED EMBODIMENTS

Embodiments of the present invention will now be described, by way of example only, with reference to the accompanying drawings.

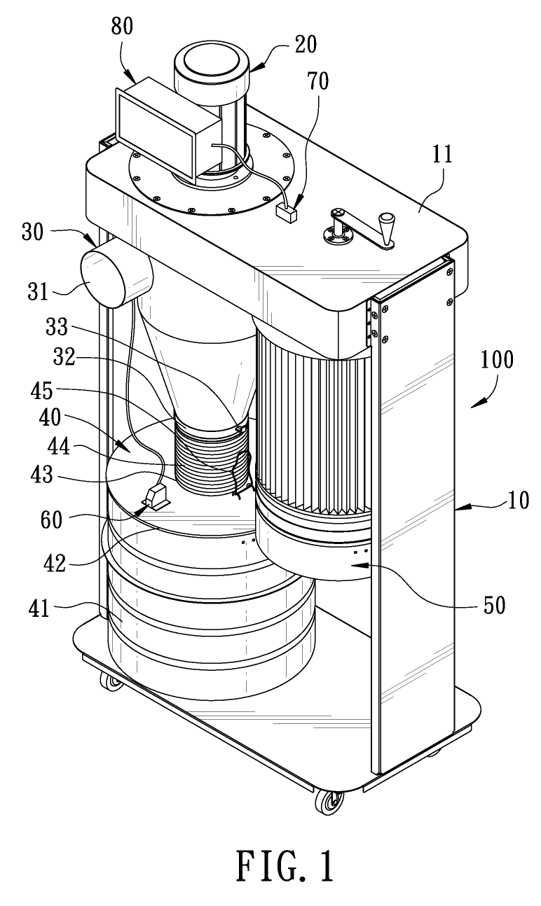

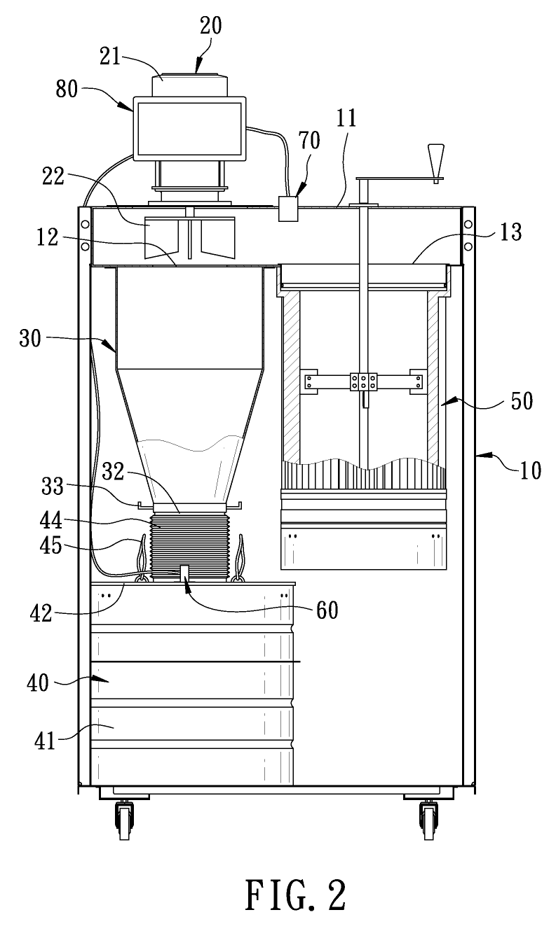

As shown in FIGS. 1 and 2, a dust-collecting apparatus 100 according to a preferred embodiment of the present invention comprises a base 10, a forced-draft fan 20, a hollow wind guide bucket 30, a dust-collecting bucket 40, a filter bucket 50, a first detector 60, a second detector 70, and a display unit 80.

The base 10 has a hollow wind guide box 11. The wind guide box 11 is formed with a wind inlet 12 and a wind outlet 13.

The forced-draft fan 20 is disposed on the wind guide box 11 and close to the wind inlet 12. The forced-draft fan 20 comprises a motor 21 and a blade 22. The motor 21 is disposed outside the wind guide box 11. The blade 22 is connected to the motor 21 and accommodated in the wind guide box 11.

The hollow wind guide bucket 30 is connected to the wind inlet 12 of the wind guide box 11. The wind guide bucket 30 has an inlet 31, a dust-collecting entrance 32, and two hooks 33 on a peripheral outer wall thereof close to the dust-collecting entrance 32.

The dust-collecting bucket 40 is connected to the dust-collecting entrance 32 of the wind guide bucket 30. In this embodiment, the dust-collecting bucket 40 includes a bucket body 41 and a lid 42 disposed on the bucket body 41. The lid 42 has an opening 43 at a central portion thereof The opening 43 is connected with the dust-collecting entrance 32 of the wind guide bucket 30 via a hose 44. The lid 42 is provided with hanging ropes 45 corresponding to the hooks 33 of the wind guide bucket 30.

The filter bucket 50 is connected to the wind outlet 13 of the wind guide box 11.

The first detector 60 is disposed on the dust-collecting bucket 40 for sending a signal when the capacity of the dust-collecting bucket 40 is not enough. In this embodiment, the first detector 60 is a proximity switch disposed on the lid 42 of the dust-collecting bucket 40.

The second detector 70 is disposed in the wind guide box 11 and close to the filter bucket 50 for sending a signal when the filter bucket 50 is blocked. In this embodiment, the second detector 70 is a pressure switch.

The display unit 80 is disposed on the base 10 and close to the motor 21 of the forced-draft fan 20. The display unit 80 is electrically connected with the first detector 60 and the second detector 70 for receiving and displaying the signals from the first detector 60 and the second detector 70.

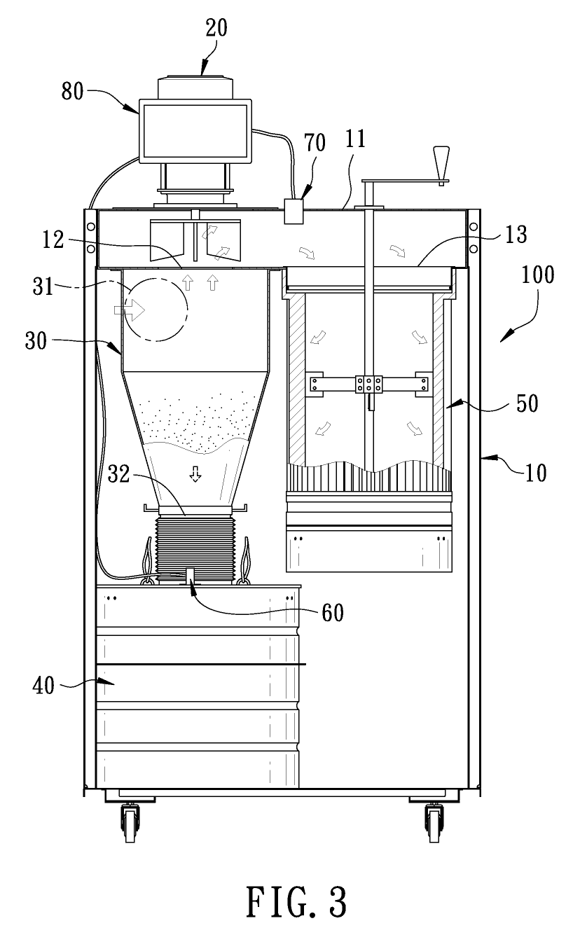

As shown in FIG. 3, when the dust-collecting apparatus 100 is started, the forced-draft fan 20 will suck external air through the inlet 31 into the wind guide bucket 30. Due to centrifugal force, larger dust particles contained in the external air will fall into the dust-collecting bucket 40 and smaller dust particles will enter the wind guide box 11 through the wind inlet 12 and enter the filter bucket 50 through the wind outlet 13 for filtering the air so as to provide an air filtration effect. The first detector 60 is a proximity switch. When the dust particles accumulated in the dust-collecting bucket 40 are going to be full, the first detector 60 will be trigged to send a signal to the display unit 80 for reminding the user that the capacity of the dust-collecting bucket 40 is not enough. The user has to clean or replace the dust-collecting bucket 40.

Besides, the second detector 70 is a pressure switch. When the filter bucket 50 is blocked, resulting in that the pressure in the wind guide box 11 exceeds the predetermined pressure value of the second detector 70, the second detector 70 will be trigged to send a signal to the display unit 80 to remind the user that the filter bucket 50 is blocked and it is necessary to replace or clean the filter bucket 50. Accordingly, the dust-collecting apparatus 100 is capable of self-monitoring and provides an automatic reminder function, such that the user doesn't have to check the dust-collecting bucket 40 and the filter bucket 50 frequently. The pressure in the wind guide box 11 will be changed by the blocking level of the filter bucket 50. Therefore, the user can set the pressure value of the second detector 70 as the standard to replace the filter bucket 50 for maintaining the quality of air and controlling the cost.

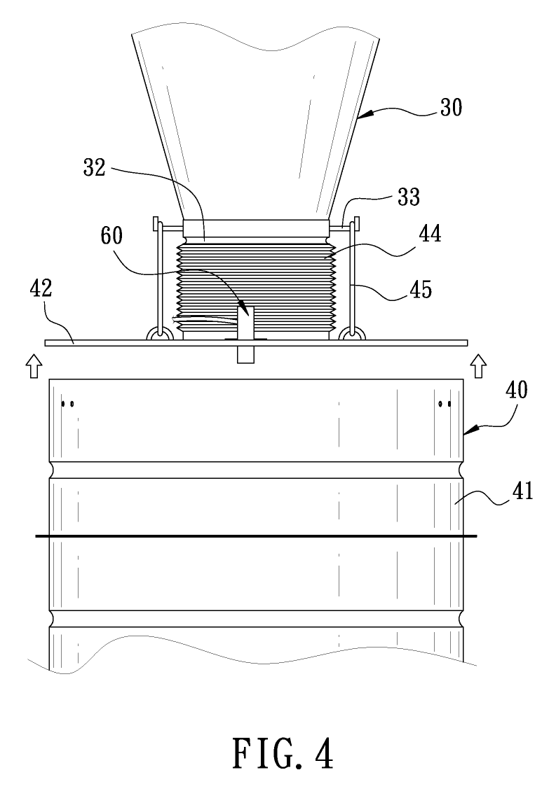

FIG. 4 is a schematic view showing the preferred embodiment of the present invention in an operating status. The lid 42 of the dust-collecting bucket 40 is connected to the dust-collecting entrance 32 of the wind guide bucket 30 via the hose 44. When the dust-collecting bucket 40 is full, the user can hang the lid 42 on the wind guide bucket 30 with the hanging ropes 45 to be hooked on the hooks 33. The lid 42 is separated from the bucket body 41, so that the user can replace or clean the bucket body 41.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A dust-collecting apparatus, comprising:
a base having a hollow wind guide box, the wind guide box being formed with at least one wind inlet and at least one wind outlet;
a forced-draft fan disposed on the wind guide box and close to the wind inlet;
a hollow wind guide bucket connected to the wind inlet of the wind guide box, the wind guide bucket having at least one inlet and at least one dust-collecting entrance;
a dust-collecting bucket connected to the dust-collecting entrance of the wind guide bucket;
a filter bucket connected to the wind outlet of the wind guide box;
a first detector disposed on the dust-collecting bucket for sending a signal when the capacity of the dust-collecting bucket is not enough;
a second detector disposed in the wind guide box and close to the filter bucket for sending a signal when the filter bucket is blocked; and
a display unit disposed on the base, the display unit being electrically connected with the first detector and the second detector for receiving and displaying the signals from the first detector and the second detector.

2. The dust-collecting apparatus as claimed in claim 1, wherein the first detector is a proximity switch.

3. The dust-collecting apparatus as claimed in claim 1, wherein the second detector is a pressure switch.

4. The dust-collecting apparatus as claimed in claim 1, wherein the dust-collecting bucket includes a bucket body and a lid disposed on the bucket body, the lid having an opening at a central portion thereof, the opening being connected with the dust-collecting entrance of the wind guide bucket via a hose, the wind guide bucket being provided with a plurality of hooks on a peripheral outer wall thereof close to the dust-collecting entrance, the lid being provided with corresponding hanging ropes to be hooked on the hooks for separating the lid and the bucket body.
